(19) United States
(12) Patent Application Publication
(10) Pub. No.: US 2016/0048831 A1
(43) Pub. Date: Feb. 18, 2016

(54) VERIFYING USER ACCOUNTS BASED ON INFORMATION RECEIVED IN A PREDETERMINED MANNER

(71) Applicant: Uber Technologies, Inc., San Francisco, CA (US)

(72) Inventor: Derrick Ongchin, San Mateo, CA (US)

(21) Appl. No.: 14/826,066

(22) Filed: Aug. 13, 2015

Related U.S. Application Data
(60) Provisional application No. 62/037,521, filed on Aug. 14, 2014.

(51) Int. Cl. G06Q 20/38

(52) U.S. Cl. CPC G06Q 20/3821

(57) ABSTRACT

A plurality of user accounts can be stored in a memory resource accessible by a computing device. A request for an on-demand service can be received at the computing device from a service application operating on a user device. The user device is associated with a first user account of the plurality of user accounts. The computing device can determine that the first user account is associated with a potentially fraudulent user. In response to determining that the first user account is associated with a potentially fraudulent user, the computing device can cause the service application to display a prompt instructing a user operating the user device to scan or capture an image of a payment card using a camera of the user device.

### RELATED APPLICATIONS

This application claims the benefit of U.S. Provisional Patent Application No. 62/037,521, filed Aug. 14, 2014, titled VERIFYING USER ACCOUNTS BASED ON INFORMATION RECEIVED IN A PREDETERMINED MANNER; the aforementioned application being incorporated by reference in its entirety.

### BACKGROUND

A significant number of electronic financial transactions occur daily as a result of the growth of e-commerce. Entities can provide portals for users to search, browse, and purchase goods or services over networks using their computing devices. Users can purchase such goods or services by providing payment information, such as their credit card numbers and their billing information, using their computing devices.

### BRIEF DESCRIPTION OF THE DRAWINGS

FIG. 1 illustrates an example system to verify user accounts, under an embodiment.

FIG. 2 illustrates an example method for verifying user accounts, according to an embodiment.

FIG. 3 illustrates another example method for verifying user accounts, under an embodiment.

FIG. 4 illustrates an example method for receiving information at a user device, according to an embodiment.

FIG. 5 is a block diagram that illustrates a computer system upon which embodiments described herein may be implemented.

FIG. 6 is a block diagram that illustrates a mobile computing device upon which embodiments described herein may be implemented.

### DETAILED DESCRIPTION

Examples described herein provide for a system to determine whether a user account is associated with a potentially fraudulent user or is subject to fraudulent use, and to perform a verification process for such a user account based on information received in a specific and predetermined manner. The system can perform the verification process to determine whether such a user account should no longer be marked or flagged as being associated with a potentially fraudulent user, or should be verified or confirmed as being fraudulent in order to prevent the user(s) from using the user account.

A user account can be created by or for a user for purpose of enabling the user to use a computing device to interact with the on-demand service system (e.g., to purchase or order a service). In some cases, a fraudulent user may create a user account and use the account in a manner that defrauds an entity that provides the on-demand service system. A fraudulent user may defraud the on-demand service system by ordering and/or paying for goods or services using falsified information (e.g., a fake name, a fake address, etc.) or misappropriated payment methods (e.g., stolen credit cards, credit card numbers, bank account information, etc.), by improperly taking advantage of promotions for the user's financial gain, by using the on-demand service system and the service application to perform illicit actions, and/or by breaching agreements or licenses under which the user agreed to use the service application to communicate with the on-demand service system. According to some examples, the on-demand service system can use information associated with a user account and historical information about past services requested and/or rendered in order to determine whether the user account is associated with a potentially fraudulent user. As described herein, a user account associated with a potentially fraudulent user is also referred to as a “potentially fraudulent user account.”

In one example, an on-demand service system, such as a transport arrangement system, can communicate with designated service applications that operate on user devices. As described herein, a designated service application can enable a user to make a request for an on-demand service using his or her computing device. In some examples, some potentially fraudulent user accounts associated with the on-demand service system can be verified by certain actions (and/or lack of other actions) that are performed by users operating the service applications. The on-demand system can determine whether information has been received in a specific and predetermined manner through communications exchanged between the on-demand service system and service applications.

According to an example, the on-demand service system can store a plurality of user accounts in a memory resource or data store accessible by the on-demand service system. A user account can be associated with a particular user and with one or more computing devices. When the on-demand service system receives a request for an on-demand service from a user device, the on-demand service system can perform a search using an identifier received with the request to identify the corresponding user account associated with the user device. By performing a search, the on-demand service system can determine whether the user account has been marked or flagged as being a potentially fraudulent user account. In some cases, because of certain information associated with a user account, a user account may be marked as being a potentially fraudulent user account even though the user of the user account is not in fact a fraudulent user. As such, the on-demand service system can provide a mechanism to enable the user to verify or confirm that the user account is not a fraudulent user account.

For example, in response to determining that the user account is associated with a potentially fraudulent user, the on-demand service system can cause the service application on the user device to display a prompt instructing a user operating the user device to perform a specified action. An example of a specified action can be to scan or capture an image of a payment card (e.g., a credit card or debit card) using a camera of the user device, or to scan or capture an image of multiple cards at the same time (e.g., two payment cards, or a payment card and a second card to match names). In addition, the on-demand service system can ignore or reject the request for the on-demand service, as opposed to processing the request as it would typically do for requests associated with user accounts that are not potentially fraudulent.

The user operating the user device can view the displayed prompt on the user device and perform the specified action on the user device. If the user properly (or correctly) performs the specified action, the service application can transmit a communication to the on-demand service system to indicate that the action was properly performed in the specified manner required. Based on the received communication, the on-demand service system can modify the first user account to include information that the first user account has been verified and/or is not associated with a potentially fraudulent user. Depending on variations, the on-demand service system can then transmit a communication to the service application to notify the user that the user's request for on-demand service is now being processed or to notify the user that he or she can now make a request for on-demand service.

Among other advantages, some examples as described enable a verification process which can detect potential fraudulent activity by a customer or user, and then enable a remotely selected verification process which that results in a remote verification (or not) of the customer or user. The verification process can, for example, require certain actions by the user which can verify the customer or user without need of involvement from a service provider (e.g., driver). In this way, the verification process can be successfully implemented at a remote location, without possibly of influence (e.g., permissiveness, collusion, lack of objectivity) from the service provider.

As used herein, a client device, a driver device, a computing device, and/or a mobile device refer to devices corresponding to desktop computers, cellular devices or smartphones, personal digital assistants (PDAs), laptop computers, tablet devices, etc., that can provide network connectivity and processing resources for communicating with the system over one or more networks. Client devices and driver devices can each operate a designated service application (e.g., a client application and a driver application, respectively) that is configured to communicate with an on-demand service arrangement system. A driver device can also correspond to a computing device that is installed in or incorporated with a vehicle, such as part of the vehicle's on-board computing system.

Still further, examples described herein relate to a variety of on-demand services, such as a transport service, a food truck service, a delivery service, an entertainment service, etc. to be arranged between users and service providers. In other examples, the system can be implemented by any entity that provides goods or services for purchase through the use of computing devices and network(s).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

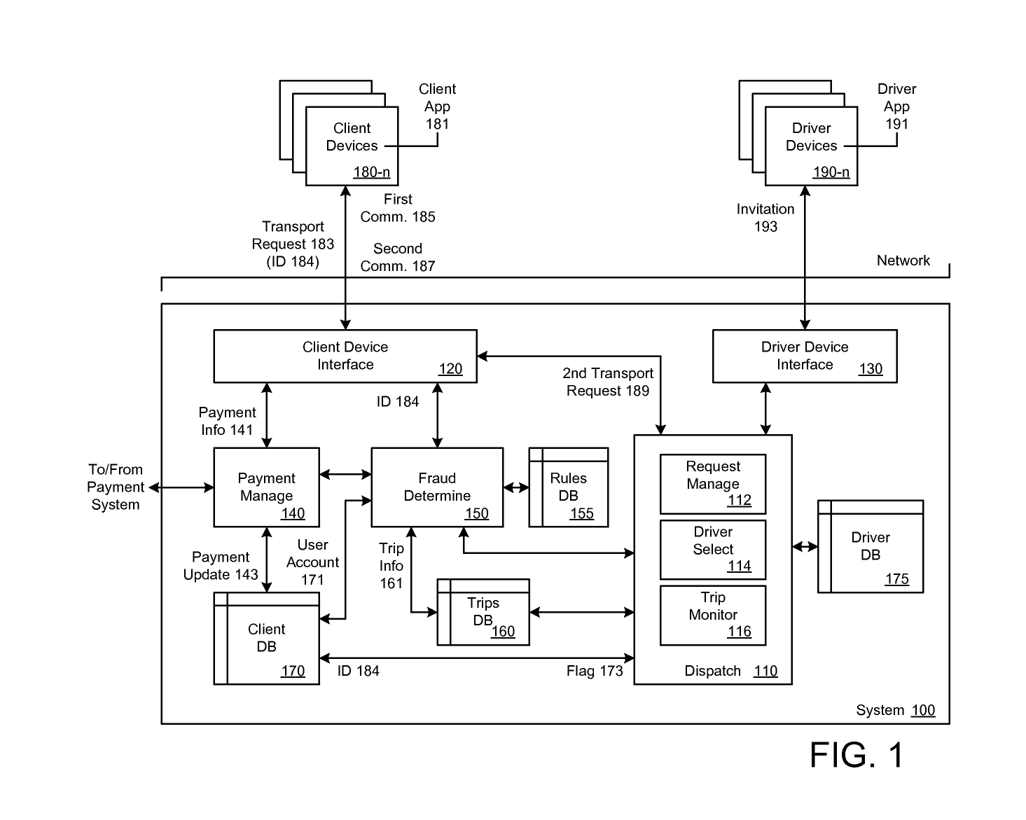

FIG. 1 illustrates an example system to verify user accounts, under an embodiment. In the example of FIG. 1, an on-demand service system 100 includes a dispatch 110, a client device interface 120, a driver device interface 130, a payment manage 140, a fraud determine 150, and a plurality of databases, such as a rules database 155, a trips database 160, a client database 170, and a driver database 175. A plurality of client devices 180 and a plurality of driver devices 190 (e.g., service provider devices) can communicate with the system 100 over one or more networks using, for example, respective designated service applications 181, 191 that are configured to communicate with the system 100. The components of the system 100 can combine to perform fraud detection processes and to arrange an on-demand service for a requesting user. Logic can be implemented with various applications (e.g., software) and/or with hardware of a computer system that implements the system 100.

Depending on implementation, one or more components of the system 100 can be implemented on network side resources, such as on one or more servers. The system 100 can also be implemented through other computer systems in alternative architectures (e.g., peer-to-peer networks, etc.). As an addition or an alternative, some or all of the components of the system 100 can be implemented on client devices, such as through applications that operate on the client devices 180 and/or the driver devices 190. For example, a client service application 181 and/or a driver service application 191 can execute to perform one or more of the processes described by the various components of the system 100. The system 100 can communicate over a network, via a network interface (e.g., wirelessly or using a wireline), to communicate with the one or more client devices 180 and the one or more driver devices 190.

The system 100 can communicate, over one or more networks, with client devices 180 and driver devices 190 using a client device interface 120 and a device interface 130, respectively. The device interfaces 120, 130 can each manage communications between the system 100 and the respective computing devices 180, 190. The client devices 180 and the driver devices 190 can individually operate client service applications 181 and driver service applications 191, respectively, that can interface with the device interfaces 120, 130 to communicate with the system 100. According to some examples, these applications can include or use an application programming interface (API), such as an externally facing API, to communicate data with the device interfaces 120, 130. The externally facing API can provide access to the system 100 via secure access channels over the network through any number of methods, such as web-based forms, programmatic access via restful APIs, Simple Object Access Protocol (SOAP), remote procedure call (RPC), scripting access, etc.

In examples described herein, the system 100 can enable users of client devices 180 to request on-demand services, such as transport services, through use of the service applications 181. The system 100 can receive a transport request from a client device 180, process the transport request by selecting a driver to provide the transport service (also referred to herein as a “trip”) for the requesting user, and notify the driver about the trip. For example, the dispatch 110 can include a request manage component 112 that receives a transport request and determines information from the request, such as an ID associated with the user and/or the client device 180, a pickup location, a vehicle type, and/or a destination location. The driver select component 114 can select a driver for the user based on the pickup location, the destination location, and/or driver information from the driver database 175 (e.g., such as the drivers' current locations and statuses).

Once the trip is arranged for the user, the trip monitor 116 can monitor the status of the transport service (e.g., by communicating with a driver device 190 of the selected driver through use of the driver service application 191). For example, the driver application 191 can communicate with a global positioning system (GPS) receiver or component of the driver device 190 and can periodically transmit location data corresponding to the current location of the driver device, determined via the GPS receiver, to the driver device interface 130. During and/or after completion of the trip, the dispatch 110 can store information about the trip (e.g., referred to herein as trip information) as a trip entry in the trips database 160, such as the user ID of the user who received the transport service, the client device ID, the driver ID, the driver device ID, the route taken, the time for pickup and the time for drop off, and/or the price for the trip, or other trip information. The dispatch 110 can repeatedly store trip entries in the trips database 160 as trips are requested and/or completed, and can associate trip entries with corresponding users. In this manner, the trips database 160 can store, for individual users, historical information about transport services that have been requested by and/or performed for that user.

The system 100 can also store and maintain user accounts in the client database 170. As described herein, a user account for a user can include a user account identifier (ID), the user's name, the user's location (e.g., home city, home address, billing address, etc.), information about the client device 180 (e.g., a device ID), the user's contact information (e.g., phone number, email address, etc.), language preference, when the user account was created (or duration since the user signed up), a profile picture, feedback or rating, past historical information about trips previously requested and/or completed for the user (e.g., by associating the user account with trip IDs of trip entries), the amount of money spent by the user, and/or payment information (e.g., debit or credit card number, credit card type, expiration date, bank account number, online payment account information, etc.). While the components of the system 100 can modify information in a user account with up-to-date information each time a trip is requested and/or completed for the user, some information of a user account can be provided and/or modified by the user in response to the user providing input via the client device 180 (e.g., such as the user's preferred email address or location, or the user's payment information).

For example, the user can associate the user account with one or more payment methods, such as a credit card, a debit card, a bank account, a gift card, online payment method, etc., by providing the corresponding payment information via the service application 181. If the user has provided multiple payment methods, the user can specify the preferred payment method to use to pay for a transport service. The system 100 can store information about the payment methods in entries in a database and associate the entries with the user account. According to one example, the service application 181 can include a user interface feature(s) in which the user can provide payment information for a payment method by (i) inputting the payment card numbers or account numbers and/or the expiration date, (ii) using the camera of the client device 180 to scan or capture an image of a payment card in order for the service application 181 to automatically detect the payment card numbers and/or the expiration date (e.g., referred to herein as an “image capture process”), or (iii) using the camera of the client device 180 to scan or capture an image of a payment card in order for the service application 181 to automatically detect the payment card numbers and then manually inputting other payment information, such as the expiration date or security code. For each payment method, the service application 181 can indicate the manner in which the user provided payment information and notify the system 100 (e.g., whether the user manually inputted the payment card numbers or used the image capture process). The payment manage 140, for example, can store in the user account an indication of when and how payment information for a payment method was provided by that user.

The system 100 can use information associated with a user account to determine whether that user account is associated with a potentially fraudulent user. In many cases, information associated with a user account can be informative of how the corresponding user uses the transport arrangement service (e.g., the user's usage behavior). For example, the information can indicate the user's propensities, such as when the user typically requests transport services (e.g., day, time of day, etc.), where the user travels to and/or from, what vehicle type(s) the user likes to travel in, how long the user typically travels (e.g., shorter trips, such as ten or fifteen minute trips, or longer trips, such as forty-five minutes or sixty minute trips, etc.), how the user typically pays for the trips, etc. The information associated with a user account can also be informative as to whether a corresponding user is behaving fraudulently.

According to some examples, the fraud determine 150 can use trip information 161 from the trips database 160 and user information from the client database 170 to determine, for individual user accounts, whether that user account is a potentially fraudulent user account. For example, for each user account (of some or all user accounts stored in the client database 170), the fraud determine 150 can determine a score that is indicative of fraud (e.g., a fraud score) based on information associated with that user account. The fraud determine 150 can determine a fraud score based on one or more rules or parameters from the rules database 155. The rules database 155 can store rules or parameters specifying what factor(s) to use to compute the fraud score and what weights (e.g., such as a multiplier or percentage to apply to a factor) to apply to what factor(s) to compute the fraud score. Weights can cause one factor to influence the fraud score more heavily than another factor. A rule or parameter can also specify the threshold fraud score. Still further, in some examples, a rule or parameter can specify when or how often the fraud determine 150 is to determine the fraud score for individual user accounts (e.g., periodically every day or every week, or every time a trip is requested or completed for a user account, etc.). The rules or parameters can be configured by a user of the system 100.

The factors that are used by the fraud determine 150 can correspond to information associated with a user account or other information derived from such information. For example, the factors used to determine the fraud score for a user account can include (i) a time when the user account was created (or a duration of time since the corresponding user signed up), (ii) the number of times the user added, deleted, or modified payment methods, (iii) the number of times a payment method was declined, (iv) the amount of money spent by the corresponding user (e.g., total amount spent, amount spent over the last specified duration of time, or amount spent within a specified duration), (v) the geographic location of the user or geographic regions where the user typically requests and/or receives transport services (e.g., the pickup and/or destination locations, whether the locations or addresses correspond to landmarks of interest, etc.), (vi) the geographic location of the user as compared to the billing address or geographic location corresponding to a payment method, (vii) whether the contact information of the user has been verified (e.g., the mobile phone number or email address), (viii) the lengths and/or prices of the transport services received (e.g., durations and/or distances of the trip), (ix) the number of times promotions are used by the corresponding user, (x) whether another user account exists that share the contact information as the account (e.g., same phone number or email address or home or billing address, etc.), (xi) whether a payment method was provided by the corresponding user using the image capture process, (xii) whether a payment method has been flagged as being a stolen or misappropriated payment method, and/or other information associated with the user account or trips requested by and/or provided for the corresponding user.

Based on the rules or parameters, for each user account, the fraud determine 150 can determine one or more of the factors associated with that user account, apply weight(s) to the one or more factors, and compute a fraud score. The fraud determine 150 can then compare the fraud score, which can be a value (e.g., zero to one hundred, or a percentage), to a default or threshold fraud score. If the fraud score for the user account is equal to or greater than the threshold fraud score, the fraud determine 150 can determine that the user account is associated with a potentially fraudulent user, and mark or flag the user account as being a potentially fraudulent user account.

In many instances, fraudulent users can behave in a similar manner. The system 100 can leverage such behavior to determine whether a user account is a potentially fraudulent user account. As an example, a fraudulent user may use one or more stolen credit cards or credit card numbers to pay for trips taken by that user. As such, in one example, the rule(s) or parameter(s) can specify that if a user has added, deleted, and/or modified payment information of payment methods at least a predefined number of times within a predefined duration of time, the fraud determine 150 is to add a first score (e.g., a predefined score or a score after applying a weight) to the overall fraud score. A fraudulent user may also typically create a user account and then spend a significant amount of money by taking many trips within a few days or weeks, for example, since creating the user account (e.g., goes on a spending spree). A fraudulent user may also take trips that are very expensive in price (e.g., as a result of receiving transport in a higher end vehicle type or as a result of traveling a long time or long distances). A rule can instruct the fraud determine 150 to add a score (which can be greater or less than a score of another factor based on the applied weights) to the overall fraud score if the amount spent within the duration exceeds a threshold spend amount.

In another example, some geographic regions or areas may be previously identified as being a region that has had a high propensity of credit card theft. A rule can instruct the fraud determine 150 to add a score if the user's home address, billing address, or past trip pickup request(s) is in such a geographic region. In addition, in many cases, fraudulent users that use misappropriated credit cards or credit card numbers typically provide credit card numbers by manually inputting the numbers using the service application 181 (as opposed to the image capture process). A rule can specify that if no payment method was provided by the corresponding user using the image capture process, a score is to be added to the fraud score. Still further, in another example, if a user account is associated with a payment method that has been flagged as being stolen (e.g., a stolen credit card), a rule can cause the fraud determine 150 to automatically mark the user account as being a potentially fraudulent account or cause the fraud determine 150 to add a score that is weighted heavily enough to automatically trigger the fraud score to exceed the threshold score.

The fraud determine 150 can determine the fraud score for individual user accounts and mark or flag those user accounts as being potentially fraudulent. In one example, the user accounts can also include the respective fraud scores. According to other examples, fraud determine 150 can associate the fraud scores with one of multiple levels of fraud, thereby marking a user account as being (i) not fraudulent, (ii) potentially fraudulent, or (iii) fraudulent or confirmed fraudulent. The system 100 can adjust or modify a potentially fraudulent user account to no longer be flagged as being potentially fraudulent based on user action performed as part of a verification process.

The system 100 can provide a mechanism to enable a user of a potentially fraudulent user account to verify that the user account is not fraudulent using communications between the system 100 and a respective client device 180. As described herein, a specific action can correspond to one or more of many actions that can be performed by the user in a predefined manner in order to verify the non-fraudulence of a user account. Such actions can be specified, for example, by one or more rules in the rules database 155. Examples of user actions can include (i) taking a photograph of the user's face and submitting the photograph, (ii) indicating on a map, an input corresponding to the last location (within a radius of a few block sizes, for example) the user requested a transport, or (iii) performing other actions.

Still further, because many fraudulent users possess stolen credit cards or stolen credit card numbers of credit cards that they do not actually have in their possession, in one example, requiring a fraudulent user to input payment information of a payment card by scanning an image of a payment card (that is associated with a previously stored payment method or is a new payment method to be used) can deter fraudulent use of the transport arrangement system. In addition, such new inputted payment card information can be used to check the validity of that payment card, to determine if another user account is associated with the same payment card, and/or to check if such a card has been flagged by a financial entity as being stolen or misappropriated.

Referring back to FIG. 1, in a first example, after the fraud determine 150 determines that a user account 171 is associated with a potentially fraudulent user and marks that user account 171 as such, the system 100 can (i) determine the next time the service application 181 is opened or activated on the corresponding client device 180, and (ii) in response, can transmit a first communication 185 to the client device 180. The first communication 185 can cause the service application 181 to display a prompt instructing the user to scan or capture an image of a payment card using the camera of the client device 180. This first communication 185 can initiate the verification process to verify or determine that a potentially fraudulent user account is, in fact, not fraudulent.

The client device interface 120 can detect when a user opens or activates a service application 181 on a client device 180. When the service application 181 is opened, a user ID and/or a client device ID (referred to herein as ID 184 for purposes of simplicity) can be provided to the client device interface 120 over one or more networks. The fraud determine 150 can receive the ID 184, access the client database 170 to determine the corresponding user account 171 based on the received ID 184, and determine if the user account 171 is marked or flagged as being potentially fraudulent. If the user account 171 is a potentially fraudulent user account, the first communication 185 can be transmitted to the service application 181 on the client device 180. In response to receiving the first communication 185, the service application 181 can prevent the user from making a transport request and can display a prompt instructing the user to scan or capture an image of a payment card. On the other hand, if the user account 171 is not determined to be a potentially fraudulent user account, no first communication 185 is transmitted and the user can operate the service application 181 normally and make a transport request, if desired.

In a second example, the system 100 can receive a transport request 183 from the client device 180, which includes the ID 184. In response to receiving the transport request 183, the system 100 can identify the corresponding user account 171 and can determine whether the user account 171 is a potentially fraudulent user account. If the user account 171 is a potentially fraudulent user account, the system 100 can transmit a first communication 185 to the service application 181 of the client device 180, such as described above, and concurrently, the system 100 can ignore or reject the transport request 183 so that the request is not processed. As a variation, instead of rejecting the transport request 183, the system 100 can suspend the processing of the transport request 183 until the verification process is completed. On the other hand, if the user account 171 is not determined to be a potentially fraudulent user account, no first communication 185 is transmitted to the service application 181 and the system 100 processes the transport request 183 normally and selects a driver, if possible, for the user.

Still further, as an addition or an alternative, in one example, the system 100 can flag or categorize the user account 171 as being a potentially fraudulent user account based on parameters associated with the transport request 183. For example, the transport request 183 can include a pickup location specified by the user (such as a current location of the user when the request was made, determined via the GPS receiver of the client device), a vehicle type, and/or a destination location. From the information received, the fraud determine 150 can determine that the fraud score associated with the user account 171 needs to be increased by a computed score amount. The new fraud score can then be above the threshold fraud score, thereby causing the user account 171 to be marked as being potentially fraudulent.

Depending on implementation, the fraud determine 150 and/or the request manage 112 of the dispatch 110 can identify the corresponding user account 171 and can determine whether the user account 171 is a potentially fraudulent user account. For example, the request manage 112 can receive the transport request 183, determine the ID 184 from the transport request 183, search the client database 170 using the ID 184 to determine the corresponding user account 171, and determine whether that user account 171 has a flag 173 indicating that the user account 171 is potential fraudulent. The request manage 112 can determine whether to ignore the request or suspend the request, depending on implementation. In another example, the fraud determine 150 can determine whether the user account 171 is a potentially fraudulent user account before the dispatch 110 receives and/or processes the transport request 183.

In response to the service application 181 receiving the first communication 185, the service application 181 can display a prompt on the display of the client device 180. The prompt can instruct the user to scan or capture an image of a payment card. According to variations, the prompt can indicate that an error has occurred and/or instruct the user to scan or capture an image of a payment card (before a request for transport can be made). The prompt may or may not provide any indication of potential fraudulence, as the potentially fraudulent user account may, in fact, not be fraudulent. In another example, the prompt can also be interactive, so that user selection of the prompt can cause the service application 181 to display a payment settings user interface.

A user can view the payment settings user interface by accessing the user's profile settings from the service application 181. In another example, the service application 181 can display the payment settings user interface in response to receiving user input of the prompt. The payment settings user interface can display one or more features corresponding to one or more payment methods that have been added to the user account. The payment settings user interface can also display a feature to enable the user to add another payment method. When the user selects an “add payment method” feature, for example, different options for adding a payment method can be presented by the service application 181. For example, a first option can correspond to a text field that that user can manually input a payment number into (e.g., a credit card number), a second option can correspond to a selectable feature for scanning or capture an image of a payment card, and a third option can correspond to a selectable feature for linking the user account with a banking account or online payment account.

According to an example, when the user selects the second option, the camera of the client device 180 can be turned on or activated and the display of the client device 180 can display the scene detected by the camera in real-time. The user can place a payment card in the view of the camera (and/or provide an input) to cause the camera to scan or capture an image of the payment card. The service application 181 can detect at least some payment information of the payment card from the image and display some of the detected payment information on the display (e.g., a credit card or debit card number and/or an expiration date). Depending on examples, the user can also manually input one or more other payment information associated with the payment card, such as the expiration date, a security code, a name on the payment card, etc.

In response to scanning or capturing the image of the payment card (or alternatively, in response to the user providing an input to submit the payment information), the service application 181 can display a user interface that includes one or more fields that is automatically populated with at least some of the payment information of the payment card. A payment number field, for example, can display the credit card or debit card numbers detected from the scanned or captured image. Still further, in one example, the service application 181 can display another prompt notifying the user that the payment card was successfully scanned or captured, and/or that the user can proceed to making a request for transport. The user interface can also include a “submit” or “add payment” feature that the user can input in order to submit the payment information as a payment method for the user account. For example, the user can verify the accuracy of the payment information that is included in the fields of the user interface (e.g., a payment number field, an expiration date field, a security code field, etc.) and select the “add payment” feature to associate the payment card with the user account as a payment method (e.g., submit the payment information).

The service application 181 can determine, from user input (or lack thereof), whether the user properly performed the specified action, e.g., whether the user provided payment information to the system 100 via the image capture process. According to an example, the service application 181 can detect if the user provided input on the payment number field that displays the payment numbers (e.g., by touching an area on the touch-sensitive display of the client device 180) and/or if the user modified any of the one or more payment numbers. If the user modifies or attempts to modify any of the payment card numbers that were obtained from the image capture process, the service application 181 can indicate that the user has interfered with the verification process and determine that the user improperly performed the specified action. In such a case, the service application 181 can display an error prompt instructing the user to try to scan or capture an image of a payment card again.

If the service application 181 determines that the user properly (e.g., in the manner instructed) performed the specified action (e.g., without manipulating or attempting to manipulate the payment card numbers), the service application 181 can transmit a second communication 187 to the system 100 to indicate that the action was properly performed in the specified manner required. On the other hand, if the service application 181 determines that the user improperly performed the specified action, the service application 181 would not transmit the second communication 187 and/or would transmit a third communication indicating that the user did not properly perform the specified action.

In addition, when the user submits the payment information that was obtained via the image capture process, the service application 181 and the system 100 can perform a validation process to ensure that the payment information 141 is valid (e.g., the payment numbers are correct, the payment card has not expired, the payment card has not been flagged as being stolen, etc.). Depending on implementation, the service application 181 can transmit the second communication 187 to the system 100 (i) before initiating the validation process, (ii) after the validation process results in the payment information 141 being validated (discussed below), or (iii) concurrently while performing the validation process. In one example, the service application 181 can perform a first validation process by checking the checksum of the payment card numbers, and if the first validation process is successful (e.g., the checksum was verified), can transmit the payment information 141 to the system 100. In response, the payment manage 140 can receive the payment information 141 and can perform a second validation process by communicating the payment information 141 to a payment system that processes and validates the authenticity of payment cards. The payment system can be a part of the system 100 or can be operated by a third party entity.

If the payment system determines that the payment information 141 is not valid, the payment manage 140 can receive a communication from the payment system indicating that the payment information 141 is declined or unauthorized for use. The payment manage 140 can transmit a communication to the service application 181 to cause the service application 181 to display an error message or prompt that notifies the user that the payment card has been declined and to scan or capture an image of another payment card. If the user does not provide payment information of another payment card via the image capture process, the user account 171 will remain flagged as being a potentially fraudulent user account. In one example, if the payment system determines that the payment information 141 is associated with a stolen or misappropriated payment card, the system 100 can automatically escalate the user account 171 from being potentially fraudulent to being confirmed fraudulent. The user account 171 can be banned from being used and the associated information from the user account 171 can be flagged as also being banned (e.g., to prevent a fraudulent user from creating another user account with the same email address, or mobile device number or ID, etc.).

Alternatively, if the payment system determines that the payment information 141 is valid, the payment manage 140 can receive a communication from the payment system indicating as such. In response, the payment manage 140 can provide a payment update 143 to the user account 171 to associate/add the payment information 141 as a payment method for the user account 171 and/or to indicate that the payment information 141 has been validated. The payment manage 140 can also communicate information to the fraud determine 150 indicating that the payment information 141 has been validated. When the fraud determine 150 receives both the second communication 187 and the information that the payment information obtained via the image capture method is valid, the fraud determine 150 can update or modify the user account 171 to indicate that the user account 171 is not fraudulent. In another example, the fraud determine 150 can also adjust the fraud score of the user account 171 to a score below the threshold score.

The payment manage 140 or the fraud determine 150 can transmit a communication to the service application 181 to cause the service application 181 to display another prompt or user interface informing that the payment method has been successfully added and that the user can continue with requesting a transport service. As an example, the user can then make a second transport request 189 using the service application 181. The request manage 112 can either bypass the initial step of determining whether the ID 184 from the second transport request 189 is associated with a potentially fraudulent user account (e.g., as a result of the fraud determine 150 providing information to the request manage 112 that the ID 184 is associated with a non-fraudulent user account) or perform the typical processing steps as previously described. The driver select 114 can select a driver to provide the transport service for the user, and provide an invitation 193 to the driver device 190 of the selected driver. After the trip is completed, the dispatch 110 can indicate to the payment manage 140 the cost of the trip so that the user can pay for the transport service using the newly provided payment method. In another example, the service application 181 can enable the user to select a different payment method than the one most recently added.

As an addition or an alternative, in one example, when the dispatch 110 receives the transport request 183 and that request manage 112 determines that the ID 184 is associated with a potentially fraudulent user, instead of rejecting the transport request 183, the request manage 112 can suspend the processing of the transport request 183 until the verification process is completed. In this case, the fraud determine 150 can provide information to the dispatch 110 that the user account associated with the ID 184 has been verified to not be fraudulent. If the request manage 112 receives this information within a predetermine amount of time since first receiving the transport request 183 (e.g., within two minutes or three minutes), the request manage 112 can process the transport request 183 for the user without having the user submit another transport request. The user can also be notified that the transport request is being or has been processed.

Additionally, in some examples, the fraud determine 150 can determine the fraud score for individual user accounts based on heuristics and/or models based on historical data. For example, if the fraud determine 150 uses a particular set of factors and weights and determines a fraud score that is greater than the threshold for each of multiple user accounts, and the corresponding users each performs the specified action to verify the non-fraudulence of those accounts, the fraud determine 150 can determine that the set of factors and/or weights should be modified or adjusted. In other words, the fraud determine 150 can determine when there are too many false positives (e.g., a predetermined number of false positives) as a result of a set of factors and weights, and can continue to modify how the fraud score is to be determined.

In another example, the fraud determine 150 can determine or generate a plurality of models based on one or more sets of factors and weights. Such a model can be identified as being non-fraudulent, potentially fraudulent, or confirmed fraudulent, for example, and have factors and/or weights configured for that model. The fraud determine 150 can compare other user accounts to the various models to determine how to characterize those user accounts. The fraud determine 150 can continuously adjust the characteristics of the model(s).

Still further, as an addition or an alternative, in one example, the fraud determine 150 can perform another determination of whether a user account is a potential fraudulent user account in response to receiving a transport request 183. For example, a user account can be previously identified by the fraud determine 150 as being non-fraudulent based on a determined fraud score. When the user makes a transport request 183 from the client device 180 associated with that user's user account, the fraud determine 150 can also use the fraud score of that user account and information from the transport request 183 and other information derived from such information to dynamically determine or adjust the fraud score (e.g., determine in real-time whether that user account is potentially fraudulent).

As an example, the transport request 183 can include a pickup location in a geographic region or area that has recently been flagged as being associated with high levels of fraud. In another example, the transport request 183 can include a pickup location and a destination location, thereby having a distance or estimated travel time that is equal to or greater than a predetermined threshold distance or estimated travel time (e.g., three hundred miles, or two hours, etc.). Still further, in another example, the fraud determine 150 can compare the transport request 183 to previous historical trips requested and taken by the user. The fraud determine 150 can determine and/or adjust the fraud score by using the variety of information as different weighted factors. Based on dynamically updating the fraud score, if the fraud determine 150 determines that the fraud score is now greater than the threshold fraud score, the fraud determine 150 can transmit the first communication 185 to the client device 180.

Methodology

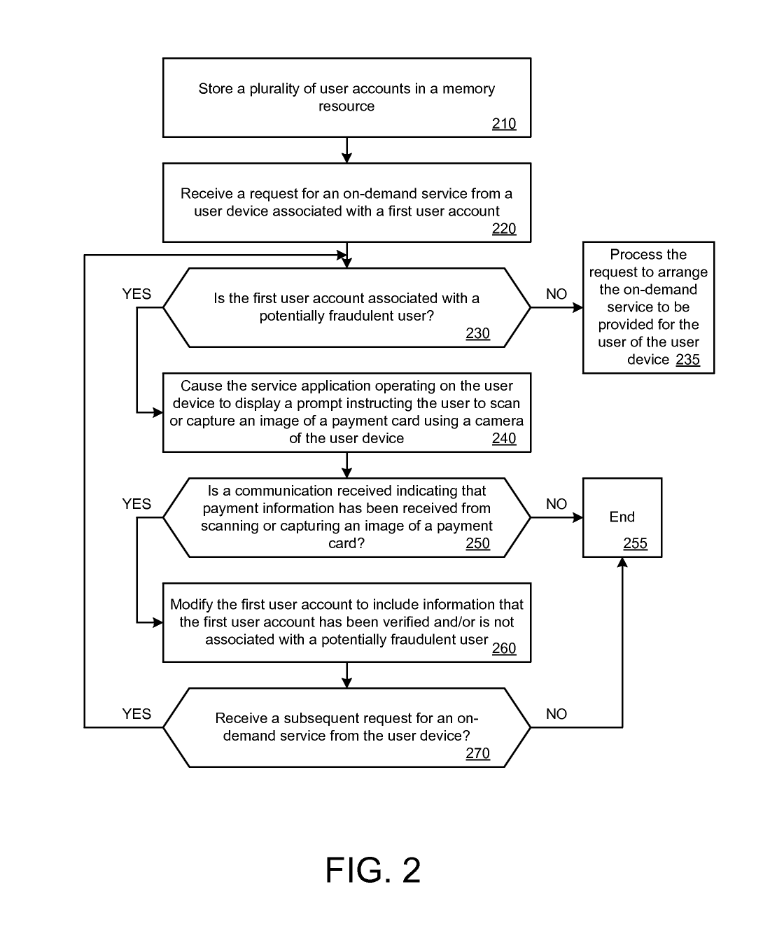

FIG. 2 illustrates an example method for verifying user accounts, according to an embodiment. A method such as described by an embodiment of FIG. 2 can be implemented using, for example, components described with an embodiment of FIG. 1. Accordingly, references made to elements of FIG. 1 are for purposes of illustrating a suitable element or component for performing a step or sub-step being described.

An on-demand service arrangement system, such as the system 100 of FIG. 1, can store a plurality of user accounts in a memory resource (210). Each user account can be associated with a user account ID, a user ID and/or user name, a client device ID (e.g., a MEID, a phone number, etc.), previous on-demand service information requested by and/or performed for the user, and/or one or more payment methods. The system 100 can receive a request for an on-demand service from a client device operated by a first user (220). Alternatively, the request can be for a purchase of an item or an electronic product (e.g., music, content in games, etc.). The client device can be associated with a user account of the first user, referred to herein as a first user account, and can run a service application configured to communicate with the system 100. In some examples, the service application can store some information associated with the first user account in a memory resource of the client device. As described herein, a first user can be a user that may have previously requested and received a transport service, or may not have yet requested a transport service (e.g., can be a first time user of the network service).

In response, the system 100 can determine whether the first user account is associated with a potentially fraudulent user (230). For example, the request can include an ID associated with the client device and/or the first user account (e.g., the user ID, the client device ID), and using the ID, the system 100 can search the user accounts stored in the memory resource to identify the first user account. The system 100 can determine whether first user account has been flagged or marked as being a potentially fraudulent user account and/or determine whether the fraud score of the first user account is equal to or greater than a predetermined threshold fraud score.

If the system 100 determines that the first user account is not associated with a potentially fraudulent user, the dispatch 110 can process the request normally by using information from the request and service provider information to select a service provider for the first user (235). On the other hand, if the first user account is determined to be a potentially fraudulent user account, the system 100 can cause the service application operating on the client device to display a prompt that instructs the user to scan or capture an image of a payment card using the camera of the client device (240). For example, the system 100 can transmit, over one or more networks, a first communication to the client device that causes the service application to display the prompt. In addition, depending on implementation, the system 100 ignores or suspends the request so that no service provider is selected for the first user to provide the on-demand service.

The system 100 can determine whether a communication is received from the service application indicating that payment information has been properly received from scanning or capturing an image of a payment card (250). If no such communication is received, the process ends (255) until the first user performs the required action. The system 100 continues to maintain the first user account as being a potentially fraudulent user account. The first user is prevented from requesting on-demand services through use of the on-demand service arrangement system using the first user account. For example, if the user scanned an image of a payment card and then tried to modify any of the numbers detected from the scan and displayed in a payment number field on the service application, the service application can determine that the payment information was not received from properly scanning or capturing the image.

If the system 100 receives a communication from the service application indicating that payment information has been received from scanning or capturing an image of a payment card, the system 100 can modify the first user account to include information that the first user account has been verified and/or that the first user account is not associated with a potentially fraudulent user (260). In one example, the system 100 can also receive payment information obtained by the image capture process and validate the payment information. The system 100 may not mark the first user account as being non-fraudulent unless it receives both the communication indicating that payment information has been properly received via the image capture process and that the payment information has been validated.

The system 100 can also transmit a message to the service application to notify the first user that the payment card was successfully scanned or captured and/or that the payment information has been associated with the first user account. The system 100 can determine whether it receives a subsequent request for on-demand service from the client device (270). If a subsequent request is received from the client device, depending on implementation, the system 100 can perform step 230 and determine that the first user account is not a potentially fraudulent user account using the process described, or automatically determine that the first user account is not fraudulent based on the recent modification of the first user account (e.g., automatically go to step 235).

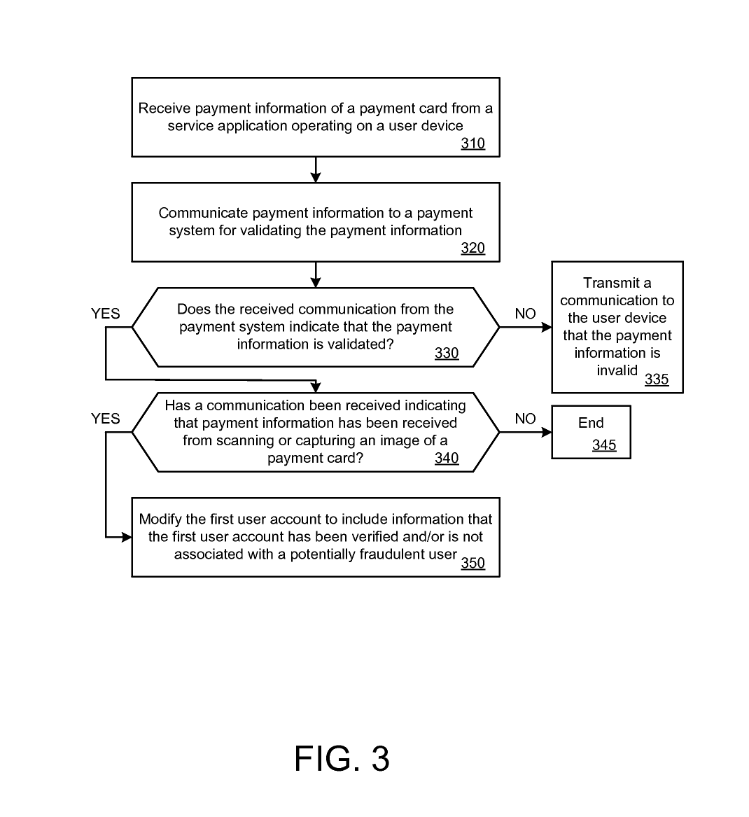

FIG. 3 illustrates another example method for verifying user accounts, under an embodiment. A method such as described by an embodiment of FIG. 3 can be implemented using, for example, components described with an embodiment of FIG. 1. Accordingly, references made to elements of FIG. 1 are for purposes of illustrating a suitable element or component for performing a step or sub-step being described.

Depending on implementation, one or more steps of FIG. 3 can be performed as part of or in conjunction with the method described in FIG. 2. For example, steps 310-330 can be performed after the system 100 has caused the service application to display a prompt instructing the first user to scan or capture an image of a payment card, as described in step 240 of FIG. 2.

Referring to FIG. 3, the first user has already viewed the prompt as a result of the system 100 determining that the first user account is a potentially fraudulent user account. In response to user action performed on the client device, the system 100 can receive payment information of a payment card from the service application (310). The first user may have scanned or captured an image of a payment card (as instructed by the prompt) and submitted the payment information of the payment card to the system 100. The payment manage 140 can communicate the payment information, via a system interface, to a payment system that processes and validates the authenticity of payment information (320). For example, the payment system can determine if the credit card or debit card numbers are accurate numbers that correspond to payment accounts that exist and determine if the payment information can be used (e.g., that there is no hold on the credit card or debit card account or is not marked as being stolen).

The payment manage 140 determines whether a communication is received from the payment system indicating that the payment information has been validated (330). If the payment system determines that the payment information is invalid (e.g., incorrect, unusable, stolen, etc.), the system 100 can transmit a communication to the client device to notify the user that the payment information has not been added and/or that an error has occurred (335). The service application can display a prompt or a message to the first user to scan or capture an image of another payment card. On the other hand, if the system 100 receives a communication from the payment system indicating that the payment information has been validated, the system 100 can determine whether the payment information should be added to or associated with the first user account. The system 100 can determine whether it has received a communication from the service application indicating that the payment information was properly received from scanning or capturing an image of a payment card (340).

For example, if the payment information is validated by the payment system but no communication is received from the service application indicating that the payment information was properly received via the image capture process, the process ends (345) until the first user performs the required image capture process properly and the respective detected payment information is validated again. The first user is prevented from requesting on-demand services through use of the on-demand service arrangement system using the first user account. Alternatively, when the payment information is validated and the system 100 has received a communication from the service application indicating that the payment information was properly received via the image scanning process (e.g., before the validation process, after the validation process, or concurrently while performing the validation process), the system 100 can modify the first user account to include information that the first user account has been verified and/or that the first user account is not associated with a potentially fraudulent user (350). The system 100 can transmit a communication to the client device to notify the user that the payment information has been associated with the first user account or has been added as a payment method to the first user account.

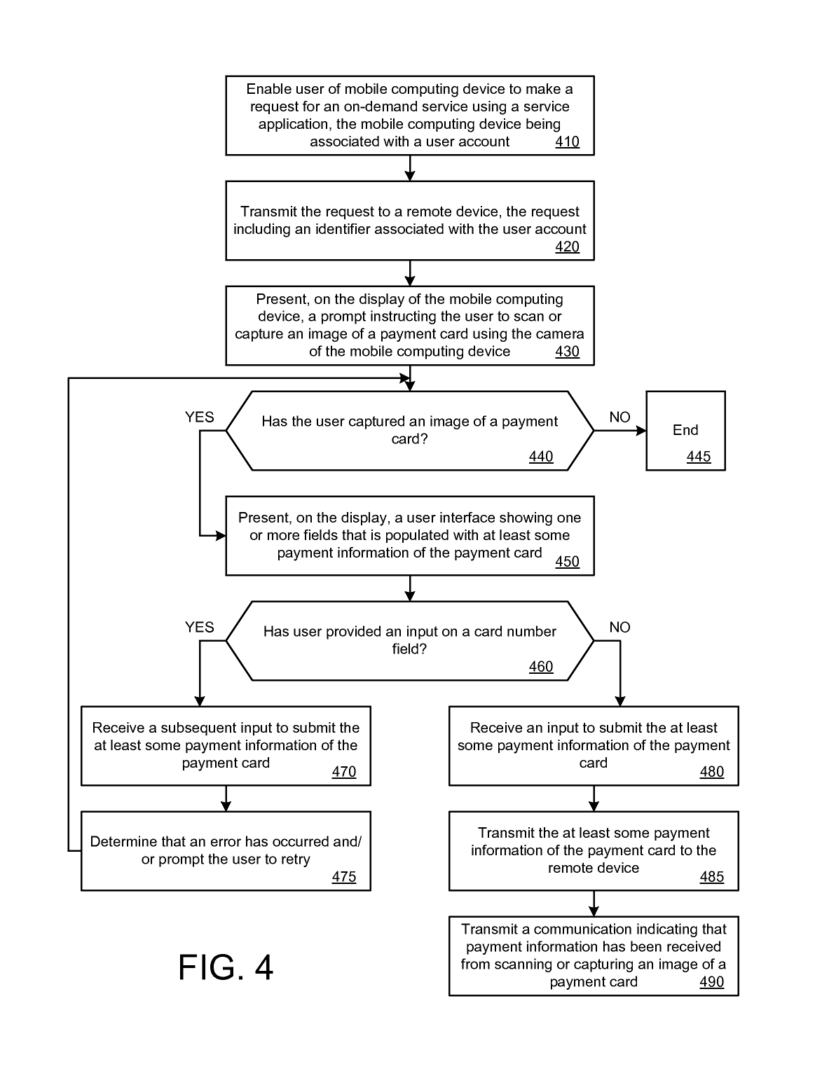

FIG. 4 illustrates an example method for receiving information at a user device for purposes of performing a verification process, according to an embodiment. A method such as described by an embodiment of FIG. 4 can be implemented using, for example, components described with an embodiment of FIG. 1. Accordingly, references made to elements of FIG. 1 are for purposes of illustrating a suitable element or component for performing a step or sub-step being described.

According to an example, the method of FIG. 4 can be performed on the client device, in conjunction with the service application. The service application can enable a user of the client device to make a request for an on-demand service. (410). The client device can be associated with a user account. For example, the user can log in on the service application to associate the user account with the service application and the client device. The user can make a request via user input and in response, the service application can transmit the request to the on-demand service arrangement system (implemented by a computing device(s) remote from the client device) (420). The request can include a user and/or a device ID and location information related to the on-demand service.

In the example of FIG. 4, the system has received the request and determined that the user account has been flagged as a potentially fraudulent user account. Accordingly, without processing the request normally, the system can cause the service application to display a predetermined prompt to cause the user to perform a specified action. The service application can present, on the display of the client device, a prompt instructing the user to scan or capture an image of a payment card (430). In one example, the service application can be configured to prevent the user from making an on-demand request.

The service application can determine whether the user has captured an image of a payment card (440). According to an example, the user can access the settings menu or feature on the service application to view a payment settings user interface. The user can select a “scan card” feature, which causes the service application to activate the camera of the client device. If the user does not capture an image of a payment card, the process ends (445) and the user is not enabled to make an on-demand request until the user performs the specified action(s).

On the other hand, if the service application detects that the user has captured or scanned an image of a payment card, the service application can detect or determine at least some payment information from the captured image of the payment card. The service application can present, on the display, a user interface that includes one or more fields that is automatically populated with at least some payment information of the payment card (450). One of the fields can be a card number field that is automatically populated with the payment card numbers detected from scanning or capturing the image of the payment card.

One purpose of the asking the user to scan an image of a payment card is to deter fraudulent use by a potentially fraudulent user. If the user was able to scan a credit card, but then change the credit card number(s) in the credit card number field, for example, the user would be able to bypass the verification process. The service application can then monitor the user inputs, if any, to determine if the user has provided an input on the card number field (460). If the user provides an input to the card number field to attempt to modify (e.g., no numbers are actually changed) or modify a payment card number(s), and then provides a subsequent input to submit the payment information (e.g., add the payment card as a payment method to the user account), the service application can receive the subsequent input (470) and can determine that an error has occurred and/or prompt the user to retry the image capture process (475). The user would have to re-scan the payment card or another payment card before the service application enables the user to make a request for an on-demand service.

On the other hand, if the user does not provide an input to the card number field to attempt to modify or modify a payment card number(s) and then provides an input to submit the payment information, the service application can receive the input (480), and transmit at least some of the payment information to the system (485). In addition, the service application can also transmit, to the system, a communication indicating that the payment information has been properly received from scanning or capturing an image of the payment card (490). Depending on implementation, step 490 can occur before, after, or concurrently with step 485.

Still further, as an addition or an alternative to FIGS. 2, 3, and/or 4, the system 100 and/or the client device can also perform an additional image processing operation(s) on the received image of a payment card for authentication purposes. For example, from the image, the system 100 and/or the service application can identify the card type and/or the company that provides the payment card, and can determine the formatting of the card (e.g., the position of the numbers, the spacing between the numbers and other text, the position of the names and/or other graphic features on the card, the size of the card, etc.) of that type or company. The system 100 can validate the authenticity of the card by comparing the parameters associated with the received image (e.g., the position of the numbers, the spacing, the position of the user's name, whether the numbers and text are raised as compared to the rest of the card, etc.) with the determined formatting or characteristics of the card of that type or company.

Hardware Diagrams

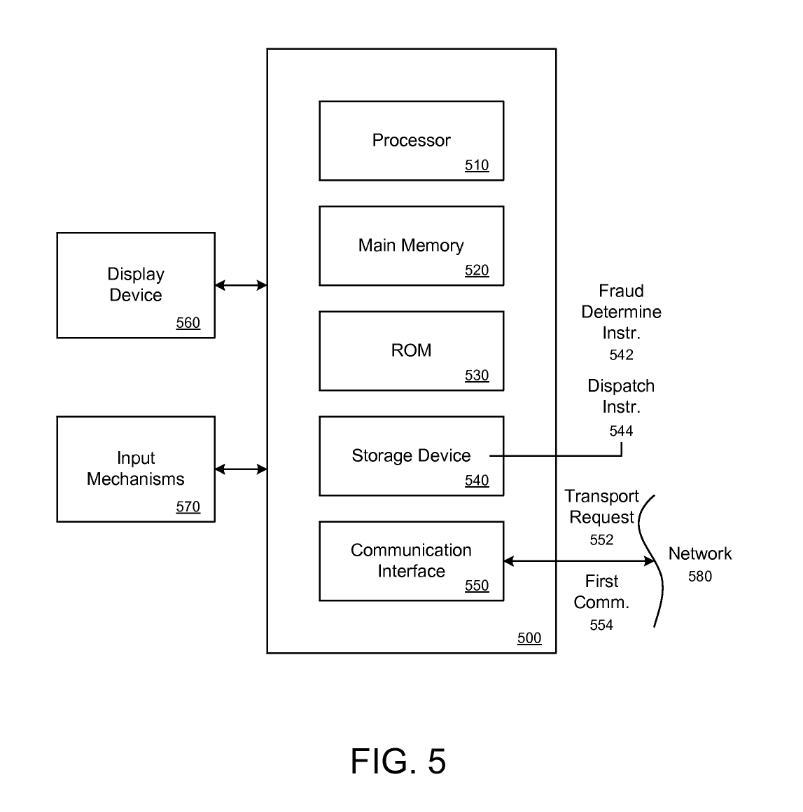

FIG. 5 is a block diagram that illustrates a computer system upon which embodiments described herein may be implemented. For example, in the context of FIG. 1, the system 100 may be implemented using a computer system such as described by FIG. 5. The system 100 may also be implemented using a combination of multiple computer systems as described by FIG. 5.

In one implementation, a computer system 500 includes processing resources 510, a main memory 520, a read only memory (ROM) 530, a storage device 540, and a communication interface 550. The computer system 500 includes at least one processor 510 for processing information and the main memory 520, such as a random access memory (RAM) or other dynamic storage device, for storing information and instructions to be executed by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions, including fraud determine instructions 542 and dispatch instructions 544.

For example, the processor 510 can execute the fraud determine instructions 542 to implement logic for determining which user accounts, if any, are potentially fraudulent user accounts, such as described in FIGS. 1 through 4. Such user accounts can be stored in the storage device 540 and/or in other storage devices accessible by the computer system 600. The processor 510 can also execute the dispatch instructions 544 to implement logic for processing requests and selecting service providers for non-fraudulent user accounts, such as described in FIGS. 1 through 4.

The communication interface 550 can enable the computer system 500 to communicate with one or more networks 580 (e.g., cellular network) through use of the network link (wireless or wireline). Using the network link, the computer system 500 can communicate with one or more other computing devices and/or one or more other servers or datacenters. In some variations, the computer system 500 can receive a transport request 552 from a client device of a user via the network link. The transport request 552 can include the user's user ID or device ID, a requested pickup location data point, a destination location data point, and/or a vehicle type selection.

The processor 510, through execution of instructions, can determine whether a user account associated with the user ID or the device ID is associated with a potentially fraudulent user. If the user account has been marked or flagged as being a potentially fraudulent user account, the processor 510, through execution of instructions, can transmit a first communication 554 to the client device, thereby causing the service application running on the client device to display a prompt instructing the user to perform a specified action before the user can request transport services, such as described in FIGS. 1 through 4.

The computer system 500 can also include a display device 560, such as a cathode ray tube (CRT), an LCD monitor, or a television set, for example, for displaying graphics and information to a user. One or more input mechanisms 570, such as a keyboard that includes alphanumeric keys and other keys, can be coupled to the computer system 500 for communicating information and command selections to the processor 510. Other non-limiting, illustrative examples of input mechanisms 570 include a mouse, a trackball, touch-sensitive screen, or cursor direction keys for communicating direction information and command selections to the processor 510 and for controlling cursor movement on the display 560.

Examples described herein are related to the use of the computer system 500 for implementing the techniques described herein. According to one embodiment, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

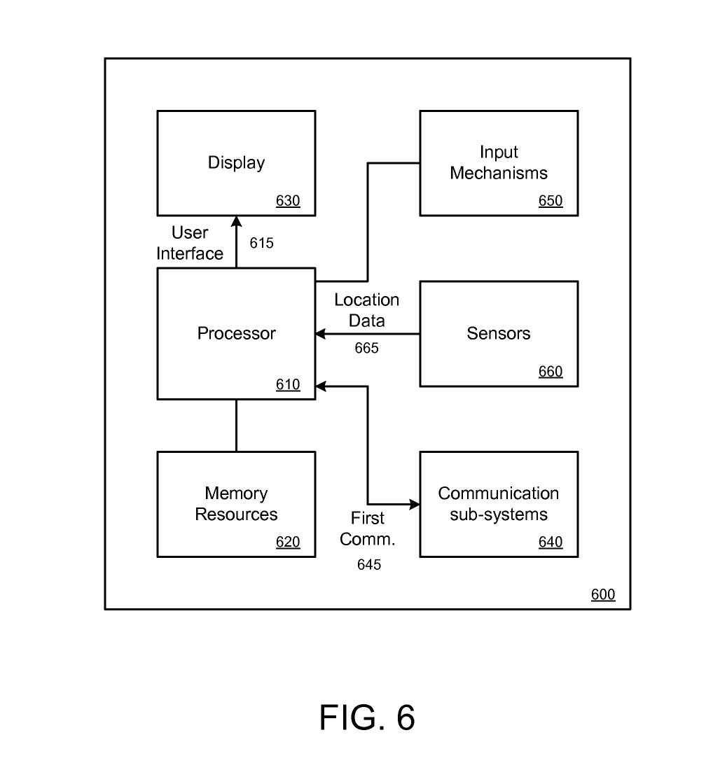

FIG. 6 is a block diagram that illustrates a mobile computing device upon which embodiments described herein may be implemented. In one embodiment, a computing device 600 may correspond to a mobile computing device, such as a cellular device that is capable of telephony, messaging, and data services. The computing device 600 can correspond to a client device or a driver device. Examples of such devices include smartphones, handsets or tablet devices for cellular carriers. The computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more sensors (e.g., a GPS component, an accelerometer, one or more cameras, etc.) 660. In one example, at least one of the communication sub-systems 640 sends and receives cellular data over data channels and voice channels.

The processor 610 can provide a variety of content to the display 630 by executing instructions and/or applications that are stored in the memory resources 620. For example, the processor 610 is configured with software and/or other logic to perform one or more processes, steps, and other functions described with implementations, such as described by FIGS. 1 through 5, and elsewhere in the application. In particular, the processor 610 can execute instructions and data stored in the memory resources 620 in order to operate a client service application, as described in FIGS. 1 through 5. Still further, the processor 610 can cause one or more user interfaces 615 to be displayed on the display 630, such as one or more user interfaces provided by the service application.

A user can operate the computing device 600 to operate the service application in order to make a request for a transport service. For example, the computing device 600 can determine a location data point 665 of the current location from the GPS component and provide the location data point 665 to the transport arrangement system (not shown in FIG. 6). The transport arrangement system can receive the request and determine whether the user's user account is a potentially fraudulent user account. If the transport arrangement system determines that the user account is a potentially fraudulent user account, it can transmit a first communication 645 to the computing device 600. The service application can display, as part of a user interface 615, a prompt that instructs the user to scan or capture an image of a payment card using the camera of the computing device 600. The user can provide input to control the camera and cause the camera to capture an image of the payment card. While FIG. 6 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method of verifying user accounts, the method being performed by a computing device and comprising:
storing, in a memory resource accessible by the computing device, a plurality of user accounts;
receiving, at the computing device, a request for an on-demand service from a service application operating on a user device associated with a first user account of the plurality of user accounts; and
determining that the first user account is associated with a potentially fraudulent user; and
in response to determining that the first user account is associated with a potentially fraudulent user, causing the service application to display a prompt instructing a user operating the user device to scan or capture an image of a payment card using a camera of the user device.

2. The method of claim 1, further comprising:
for each of some of the plurality of user accounts, determining whether that user account is associated with a potentially fraudulent user by generating a score for that user account based on one or more factors associated with that user account.

3. The method of claim 2, wherein, for each of some of the plurality of user accounts, determining whether that user account is associated with a potentially fraudulent user includes comparing the score for that user account to a threshold score to determine whether the score for that user account is equal to or exceeds the threshold score.

4. The method of claim 2, wherein the one or more of factors includes at least one of (i) a time when a user account was created, (ii) an amount of money spent in a duration of time, or (iii) a geographic location associated with the user account and a geographic location associated with at least one of one or more payment methods associated with the user account.

5. The method of claim 4, wherein the one or more factors further includes a determination whether information corresponding to at least one of the one or more payment methods was previously provided by scanning or capturing an image of a payment card corresponding to the at least one of the one or more payment methods.

6. The method of claim 1, wherein each of the plurality of user account includes information about one or more payment methods previously associated with that user account, and wherein for each payment method, the information includes (i) a payment identifier, (ii) a payment type, (iii) one or more payment card numbers, and (iv) an expiration date.

7. The method of claim 1, wherein causing the service application to display the prompt includes transmitting a first communication to the user device, and further comprising:
after causing the service application to display the prompt, receiving, from the service application, a second communication indicating that payment information has been received from scanning or capturing an image of a payment card.

8. The method of claim 7, further comprising:
in response to receiving the second communication, modifying the first user account to include at least one of (i) information that the first user account has been verified, or (ii) information that the first user account is not associated with a potentially fraudulent user.

9. The method of claim 8, further comprising:
receiving, at the computing device, a second request for the on-demand service from the service application; and
in response to receiving the second request, processing the second request to arrange the on-demand service to be provided for the user operating the user device by a service provider.

10. A non-transitory computer-readable medium storing instructions that, when executed by a processor of a computing device, causes the computing device to:
store, in a memory resource accessible by the computing device, a plurality of user accounts;
receive, at the computing device, a request for an on-demand service from a service application operating on a user device associated with a first user account of the plurality of user accounts;
determine that the first user account is associated with a potentially fraudulent user; and
in response to determining that the first user account is associated with a potentially fraudulent user, cause the service application to display a prompt instructing a user operating the user device to scan or capture an image of a payment card using a camera of the user device.

11. The non-transitory computer-readable medium of claim 10, wherein the instructions cause the computing device to further:
for each of some of the plurality of user accounts, determine whether that user account is associated with a potentially fraudulent user by generating a score for that user account based on one or more factors associated with that user account, the one or more of factors including at least one of (i) a time when a user account was created, (ii) an amount of money spent in a duration of time, or (iii) a geographic location associated with the user account and a geographic location associated with at least one of one or more payment methods associated with the user account.

12. The non-transitory computer-readable medium of claim 10, wherein the instructions cause the service application to display the prompt by transmitting a first communication to the user device, and wherein the instructions cause the computing device to further:
after causing the service application to display the prompt, receive, from the service application, a second communication indicating that payment information has been received from scanning or capturing an image of a payment card.

13. The non-transitory computer-readable medium of claim 12, wherein the instructions cause the computing device to further:
in response to receiving the second communication, modify the first user account to include at least one of (i) information that the first user account has been verified, or (ii) information that the first user account is not associated with a potentially fraudulent user.

14. The non-transitory computer-readable medium of claim 13, wherein the instructions cause the computing device to further:
receive, at the computing device, a second request for the on-demand service from the service application; and
in response to receiving the second request, process the second request to arrange the on-demand service to be provided for the user operating the user device by a service provider.

15. A method of verifying user accounts, the method being performed by a mobile computing device and comprising:
enabling a user of the mobile computing device to make a request for an on-demand service using a service application operating on the mobile computing device, the mobile computing device being associated with a user account;
transmitting, to a remote device, the request for the on-demand service, the request including an identifier associated with the user account; and
presenting, on a display of the mobile computing device, a prompt instructing the user to scan or capture an image of a payment card using a camera of the mobile computing device, wherein the prompt is presented as a result of the remote device determining that the user account is associated with a potentially fraudulent user.

16. The method of claim 15, wherein presenting the prompt includes receiving, over one or more networks, a communication from the remote device that causes the service application to display the prompt.

17. The method of claim 15, further comprising:
capturing an image of a payment card using the camera of the mobile computing device; and
in response to capturing the image of the payment card, presenting, on the display, a user interface that includes one or more fields that is populated with at least some payment information of the payment card.

18. The method of claim 17, further comprising:
receiving, at the mobile computing device, a first user input on a card number field of the one or more fields;
subsequently receiving, at the mobile computing device, a second user input to submit the at least some payment information of the payment card; and
in response to receiving the second user input to submit the at least some information from the payment card, determine that an error has occurred as a result of previously receiving the first user input on the card number field.

19. The method of claim 17, further comprising:
receiving, at the mobile computing device, a user input to submit the at least some information of the payment card; and
in response to receiving the user input to submit the at least some information of the payment card, transmitting, from the mobile computing device, a communication to the remote device indicating that payment information has been received from scanning or capturing an image of the payment card.

20. The method of claim 19, further comprising:
in response to receiving the user input to submit the at least some information of the payment card, concurrently presenting, on the display, a second prompt indicating that the payment card has been successfully scanned or captured.
